(19) United States
(12) Patent Application Publication
(10) Pub. No.: US 2021/0147634 A1
(43) Pub. Date: May 20, 2021

(54) (POLY) GLYCEROL-BASED ALKOXYSILANE

(71) Applicant: SAKAMOTO YAKUHIN KOGYO CO., LTD., Osaka (JP)

(72) Inventors: Shiori HARADA, Osaka (JP); Hikaru OGAWA, Osaka (JP); Yukiko TANIHATA, Osaka (JP); Kimihiro MATSUKAWA, Osaka (JP)

(73) Assignee: SAKAMOTO YAKUHIN KOGYO CO., LTD., Osaka (JP)

(21) Appl. No.: 16/952,362

(22) Filed: Nov. 19, 2020

(30) Foreign Application Priority Data
Nov. 20, 2019 (JP) 2019209600
Oct. 21, 2020 (JP) 2020176721

(51) Int. Cl. C08G 77/18; C09D 183/06

(52) U.S. Cl. CPC C08G 77/18; C09D 183/06

(57) ABSTRACT

A (poly)glycerol-based alkoxysilane having a (poly)glycerol skeleton with an average polymerization degree of 1 to 100, and a plurality of alkoxysilyl groups at a terminal is provided as a novel material capable of imparting sustainable anti-fogging properties to a base material such as glass.

### BACKGROUND OF THE INVENTION

### Field of the Invention

The present invention relates to a (poly)glycerol-based alkoxysilane.

### Description of the Related Art

A base material such as glass and plastic with high transparency for use as optical films, glass, and lenses has a problem of impaired visibility due to fog caused by dew formation on the base material surface under high-temperature and high-humidity conditions or large-temperature-difference conditions.

Examples of a conventional method for preventing the fogging phenomenon include preparing a coating film for imparting anti-fogging effect to the base material surface. For example, a method of applying a solution containing a surfactant or a surfactant and a hydrophilic polymer to the base material surface to hydrophilize the surface for prevention of formation of water droplets is disclosed (Japanese Patent Laid-Open No. 3-215589).

The anti-fogging composition in Japanese Patent Laid-Open No. 3-215589, however, has high hydrophilicity, so that a coating film with low resistance to water is formed, which leads to a problem of disappearance of the effect when washed away with water. Further, the anti-fogging composition has no chemical bond with a glass surface or a plastic material, so that although the anti-fogging effect is exhibited immediately after coating, the composition easily peels off from a base material surface to cause degradation of the anti-fogging effect. In other words, the composition has low durability of the anti-fogging effect.

It is an object of the present invention to provide a novel material capable of imparting sustainable anti-fogging properties to a base material such as glass and plastic.

### SUMMARY OF THE INVENTION

As a result of extensive study by the present inventors, it has been found that a (poly)glycerol-based alkoxysilane having a (poly)glycerol skeleton with an average polymerization degree of 1 to 100, and a plurality of alkoxysilyl groups at a terminal solves the problem, so that the present invention has been completed.

The (poly)glycerol-based alkoxysilane of the present invention imparts anti-fogging properties to a base material such as glass and plastic and has an excellent sustainability of the anti-fogging effect.

### DETAILED DESCRIPTION OF THE PREFERRED EMBODIMENT

Although the present invention is described based on an embodiment, the scope of the present invention is not limited to the embodiment, and another embodiment with alteration made without damaging the effect of the present invention may be included in the present invention. Incidentally, a range specified by using “to” includes an upper limit and a lower limit.

The present invention relates to a (poly)glycerol-based alkoxysilane having a (poly)glycerol skeleton with an average polymerization degree of 1 to 100, and a plurality of alkoxysilyl groups at a terminal. Incidentally, the (poly)glycerol represents glycerol or a polyglycerol.

The (poly)glycerol according to the present invention has an average polymerization degree of 1 to 100, preferably 2 to 20, most preferably 2 to 15. The average polymerization degree is calculated from the hydroxyl value obtained by terminal analysis method based on the following equation (2) and the following equation (3). In the equation (3), the hydroxyl value is a numerical value as index of the number of hydroxyl groups contained in (poly)glycerol, referred to as the number of milligram of potassium hydroxide required for neutralization of acetic acid used for acetylation of free hydroxyl group contained in 1 g of (poly)glycerol. The value of milligram of potassium hydroxide is calculated according to “JOCS, Standard Methods for Analysis of Fats and Oils (2013)” edited by Japan Oil Chemists' Society.

Molecular weight=74n+18 (2)

Hydroxyl value=56110(n+2)/Molecular weight (3)

It is preferable that the (poly)glycerol-based alkoxysilane of the present invention be a reaction product obtained by reacting a (poly)glycerol or (poly)glycerol derivative having a first reactive functional group at a terminal with an alkoxysilane having a second reactive functional group at a terminal.

It is preferable that the (poly)glycerol or (poly)glycerol derivative having a first reactive functional group at a terminal be a compound with a structure represented by the following formula (1):

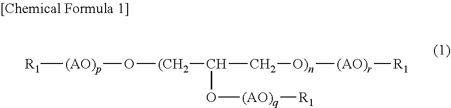

wherein n, p, q and r each represent the number of repeating unit, n being an integer of 1 to 20, p, q and r each being an integer of 0 to 50; AO represents an alkylene oxide having 1 to 4 carbon atoms; and R₁ represents reactive functional groups which may be the same or different and are selected from the group consisting of hydrogen, a thiol group, a (meth)acryloyl group, an epoxy group and an allyl group at a terminal.

Examples of AO include ethylene oxide (EO), propylene oxide (PO) and butylene oxide (BO), and ethylene oxide (EO) is preferred. Any of p, q and r described in the formula (1) represents an average number of alkylene oxide added to one hydroxyl group of a polyglycerol, each being preferably 0 to 50, more preferably 1 to 20. The sum of p, q and r, i.e., (p+q+r), is preferably 1 to 130, more preferably 5 to 120.

Specific examples of the (poly)glycerol or (poly)glycerol derivative having a first reactive functional group at a terminal include a (poly)glycerol, a (poly)glycerol alkylene oxide adduct, a (poly)glycerol(alkylene oxide)thioglycolic acid ester, a (poly)glycerol(alkylene oxide)3-mercaptopropionic acid ester, a (poly)glycerol(alkylene oxide)(meth)acrylate, a (poly)glycerol(alkylene oxide)(poly)glycidyl ether, and a (poly)glycerol(alkylene oxide)(poly)allyl ether.

The second reactive functional group is not particularly limited, and examples thereof include a vinyl group, an isocyanate group, a thiol group, a (meth)acryloyl group, an epoxy group, a hydroxyl group, and an amino group. Examples of the alkoxysilane having the second reactive functional group at an end include vinyltrimethoxysilane, vinyltriethoxysilane, 3-isocyanate propyltriethoxysilane, 3-isocyanate propyltrimethoxysilane, 3-mercaptopropyl methyldimethoxysilane, 3-mercaptopropyl trimethoxysilane, 3-methacryloxypropyl trimethoxysilane, 3-methacryloxypropyl methyldiethoxysilane, 3-acryloxypropyl trimethoxysilane, 3-glycidoxy propyltrimethoxysilane, 3-glycidoxy propylmethyldiethoxysilane, N-2-(aminoethyl)-3-aminopropyl methyldimethoxysilane, 3-aminopropyl trimethoxysilane, 3-hydroxypropyl triethoxysilane, and 3-aminopropyl triethoxysilane.

It is preferable that the (poly)glycerol-based alkoxysilane of the present invention be obtained by reacting a first reactive functional group included at a terminal of a (poly)glycerol or a (poly)glycerol derivative with a second reactive functional group at a terminal of an alkoxysilane. Specific examples thereof include a reaction product of a (poly)glycerol, a (poly)glycerol alkylene oxide adduct or a (poly)glycerol derivative having a thiol group at a terminal with an alkoxysilane containing any one of a vinyl group, an isocyanate group, an epoxy group and an amino group at a terminal; a reaction product of a (poly)glycerol derivative having a (meth)acryloyl group at a terminal or a (poly)glycerol derivative having an allyl group at a terminal with an alkoxysilane having a vinyl group, a thiol group or a (meth)acryloyl group at a terminal; and a reaction product of a (poly)glycerol derivative having an epoxy group at an end with an alkoxysilane including a thiol group, a hydroxy group or amino group at a terminal. With respect to the reaction product obtained, it is preferable that 20 to 100% of the first reactive functional groups of a (poly)glycerol or a (poly)glycerol derivative react to be bonded, and it is more preferable that 50 to 100% of the first reactive functional groups react to be bonded.

The polyglycerol-based alkoxysilane of the present invention is suitably used as an anti-fogging agent, a dew formation preventing agent, or a stress reliever. In the case of using as an anti-fogging agent, a dew formation preventing agent, or a stress reliever, the polyglycerol-based alkoxysilane may be made into a coating composition containing a silicate monomer such as TMOS and TEOS, a silicate oligomer such as methyl silicate and ethyl silicate, a polysilsesquioxane, etc. The coating composition is cured into a cured coating film excellent in anti-fogging properties for a base material such as glass and plastic. Accordingly, the coating composition is suitably used as an anti-fogging coating agent for a windshield of vehicles, a lamp cover, a camera lens, goggles, etc.

### EXAMPLES

The present invention is described with reference to Examples below, though the present invention is not limited thereto.

### Synthesis Example 1

A reaction vessel having a thermometer, a stirrer and a Dean-Stark apparatus was charged with 764 g of tetraglycerol (a polyglycerol having an average polymerization degree of 4) EO 60-mol adduct, 163 g of 3-mercaptopropionic acid, 900 g of toluene, and 45 g of p-toluenesulfonic acid. While stirring the mixture, the temperature was raised to that of toluene reflux atmosphere to perform a dehydration condensation reaction for about 6 hours. After completion of the reaction, neutralization was performed with sodium hydrogen carbonate, and extraction was performed with ethyl acetate:toluene=50:50. An organic layer was distilled away under reduced pressure to obtain 367 g of 3-mercaptopropionic acid ester of tetraglycerol EO 60-mol adduct. A reaction vessel having a stirrer was charged with 319 g of 3-mercaptopropionic acid ester of tetraglycerol EO 60-mol adduct and 81 g of vinyltrimethoxysilane. The mixture was stirred for 45 minutes while exposed with UV light to obtain 400 g of an alkoxysilane compound A1. Incidentally, 100% of the hydroxyl groups at a terminal of the polyglycerol derivative were reacted.

### Synthesis Example 2

A reaction vessel having a thermometer and a stirrer was charged with 425 g of tetraglycerol EO 60-mol adduct, 210 g of 3-isocyanate propyltriethoxysilane (manufactured by TCI), and 0.13 g of dibutyltin dilaurate, and the mixture was stirred in an incubator set at 40° C. for 4 hours to obtain 635 g of an alkoxysilane compound A2. Incidentally, 100% of hydroxyl groups at a terminal of a polyglycerol derivative were reacted.

### Synthesis Example 3

A reaction vessel having a thermometer and a stirrer was charged with 66 g of diglycerol EO 40-mol adduct, 34 g of 3-isocyanate propyltriethoxysilane (manufactured by TCI), and 0.01 g of dibutyltin dilaurate, and the mixture was stirred in an incubator set at 60° C. for 12 hours to obtain 100 g of an alkoxysilane compound A3. Incidentally, 100% of hydroxyl groups at a terminal of a polyglycerol derivative were reacted.

### Synthesis Example 4

A reaction vessel having a thermometer and a stirrer was charged with 66 g of decaglycerol EO 120-mol adduct, 34 g of 3-isocyanate propyltriethoxysilane (manufactured by TCI), and 0.01 g of dibutyltin dilaurate, and the mixture was stirred in an incubator set at 40° C. for 4 hours to obtain 100 g of an alkoxysilane compound A4. Incidentally, 100% of hydroxyl groups at a terminal of a polyglycerol derivative were reacted.

### Synthesis Example 5

A reaction vessel having a thermometer and a stirrer was charged with 28 g of tetraglycerol EO 6-mol adduct, 72 g of 3-isocyanate propyltriethoxysilane (manufactured by TCI), and 0.01 g of dibutyltin dilaurate, and the mixture was stirred in an incubator set at 60° C. for 11 hours to obtain 100 g of an alkoxysilane compound A5. Incidentally, 100% of hydroxyl groups at a terminal of a polyglycerol derivative were reacted.

### Synthesis Example 6

A reaction vessel having a thermometer and a stirrer was charged with 29 g of tetraglycerol EO 7-mol adduct, 71 g of 3-isocyanate propyltriethoxysilane (manufactured by TCI), and 0.01 g of dibutyltin dilaurate, and the mixture was stirred in an incubator set at 60° C. for 6 hours to obtain 100 g of an alkoxysilane compound A6. Incidentally, 100% of hydroxyl groups at a terminal of a polyglycerol derivative were reacted.

### Synthesis Example 7

A reaction vessel having a thermometer and a stirrer was charged with 31 g of tetraglycerol EO 8-mol adduct, 69 g of 3-isocyanate propyltriethoxysilane (manufactured by TCI), and 0.01 g of dibutyltin dilaurate, and the mixture was stirred in an incubator set at 60° C. for 5 hours to obtain 100 g of an alkoxysilane compound A7. Incidentally, 100% of hydroxyl groups at a terminal of a polyglycerol derivative were reacted.

### Synthesis Example 8

A reaction vessel having a thermometer and a stirrer was charged with 37 g of tetraglycerol EO 12-mol adduct, 63 g of 3-isocyanate propyltriethoxysilane (manufactured by TCI), and 0.01 g of dibutyltin dilaurate, and the mixture was stirred in an incubator set at 60° C. for 5 hours to obtain 100 g of an alkoxysilane compound A8. Incidentally, 100% of hydroxyl groups at a terminal of a polyglycerol derivative were reacted.

### Synthesis Example 9

A reaction vessel having a thermometer and a stirrer was charged with 44 g of tetraglycerol EO 12-mol adduct, 56 g of 3-isocyanate propyltriethoxysilane (manufactured by TCI), and 0.01 g of dibutyltin dilaurate, and the mixture was stirred in an incubator set at 60° C. for 2 hours to obtain 100 g of an alkoxysilane compound A9. Incidentally, 75% of hydroxyl groups at a terminal of a polyglycerol derivative were reacted.

### Synthesis Example 10

A reaction vessel having a thermometer and a stirrer was charged with 54 g of tetraglycerol EO 12-mol adduct, 46 g of 3-isocyanate propyltriethoxysilane (manufactured by TCI), and 0.01 g of dibutyltin dilaurate, and the mixture was stirred in an incubator set at 60° C. for 2 hours to obtain 100 g of an alkoxysilane compound A10. Incidentally, 50% of hydroxyl groups at a terminal of a polyglycerol derivative were reacted.

### Synthesis Example 11

A reaction vessel having a thermometer and a stirrer was charged with 73 g of tetraglycerol EO 60-mol adduct, 27 g of 3-isocyanate propyltriethoxysilane (manufactured by TCI), and 0.01 g of dibutyltin dilaurate, and the mixture was stirred in an incubator set at 60° C. for 12 hours to obtain 100 g of an alkoxysilane compound A11. Incidentally, 75% of hydroxyl groups at a terminal of a polyglycerol derivative were reacted.

### Synthesis Example 12

A reaction vessel having a thermometer and a stirrer was charged with 80 g of tetraglycerol EO 60-mol adduct, 20 g of 3-isocyanate propyltriethoxysilane (manufactured by TCI), and 0.01 g of dibutyltin dilaurate, and the mixture was stirred in an incubator set at 60° C. for 6 hours to obtain 100 g of an alkoxysilane compound A12. Incidentally, 50% of hydroxyl groups at a terminal of a polyglycerol derivative were reacted.

### Example 1

A coating composition was obtained by uniformly stirring 1.0 g of the alkoxysilane compound A1, 1.5 g of 1-methoxy-2-propanol, 0.27 g of water, and 0.1 g of 0.1 wt % nitric acid aqueous solution. The coating composition was applied to a hydrophilized glass plate (76 mm by 52 mm by 1.2 mm) to a film thickness of about 30 μm, and heated and dried at 150° C. for 30 minutes to obtain a cured coating film. As hydrophilic treatment, the glass plate was immersed in an alkali solution (mixture solution of 500 mL of isopropanol, 41.6 g of potassium hydroxide, and 83.3 g of ion-exchanged water) for 15 hours, and washed with 0.2 mol/L of hydrochloric acid aqueous solution and ion-exchanged water.

### Examples 2 to 12

A coating composition and a cured coating film were made in the same manner as in Example 1, except that the alkoxysilane compound A1 used in Example 1 was replaced with each of the alkoxysilane compounds A2 to A12.

The anti-fogging properties of the cured coating films in Examples 1 to 12 were evaluated based on the following anti-steam fogging properties. Further, the durability of the anti-fogging effect of the cured coating films in Examples 1 and 2 was also evaluated.

### (Anti-Steam Fogging Properties)

A cured coating film was disposed at a position 2.0 cm above the liquid level of water controlled at a temperature of 50° C. for evaluation through visual observation whether the cured coating film was fogged or not, and the time when the coating film began to be fogged was measured.

### (Durability of Anti-Fogging Effect)

The durability of anti-fogging effect was evaluated as follows. After the evaluation on anti-steam fogging properties, the moisture attached to the coating film surface was wiped off with paper. The coating film was left standing for 15 minutes at 25° C. and 60 RH % to dry the coating film surface, and then disposed at a position 2.0 cm above the liquid level of water adjusted at a temperature of 50° C. The procedure described above was repeated 5 times for evaluation.

### Comparative Example 1

Using a glass plate immersed in an alkali solution (a mixture solution of 500 mL of isopropanol, 41.6 g of potassium hydroxide, and 83.3 g of ion-exchanged water) for 15 hours, and washed with 0.2 mol/L of hydrochloric acid aqueous solution and ion-exchanged water, the anti-steam fogging properties and the durability of anti-fogging effect were evaluated.

The ingredients and contents thereof and evaluation results for Examples 1 to 12 and Comparative Example 1 are shown in Table 1 and Table 2. Incidentally, the compositions in Examples 1 and 2 with the ingredients and contents thereof as shown in Table 1 were independently prepared.

TABLE 1

| | | | | | | | | | | | | | | | Comparative |
|---|---|---|---|---|---|---|---|---|---|---|---|---|---|---|---|
| | | | Example | | | | | | | | | | | | Example |
| | | | 1 | 2 | 3 | 4 | 5 | 6 | 7 | 8 | 9 | 10 | 11 | 12 | 1 |
| Ingredients | (Poly)glycerol- | A1 | 37.4 | | | | | | | | | | | | |
| and contents | based | A2 | | 37.4 | | | | | | | | | | | |
| thereof (part | alkoxysilane | A3 | | | 37. 5 | | | | | | | | | | |
| by weight) | | A4 | | | | 37.5 | | | | | | | | | |
| | | A5 | | | | | 17.3 | | | | | | | | |
| | | A6 | | | | | | 17. 3 | | | | | | | |
| | | A7 | | | | | | | 17.4 | | | | | | |
| | | A8 | | | | | | | | 17.6 | | | | | |
| | | A9 | | | | | | | | | 17.8 | | | | |
| | | A10 | | | | | | | | | | 18.2 | | | |
| | | A11 | | | | | | | | | | | 38.5 | | |
| | | A12 | | | | | | | | | | | | 39.7 | |
| | Ion-exchanged water | | 10.1 | 10.1 | 13.7 | 13.7 | 8.3 | 8.1 | 7.8 | 6.9 | 9.9 | 8.1 | 11.5 | 8.7 | |
| | Acid | 1% Nitric | 3.7 | 3.7 | | | 5.2 | 5.2 | 5.2 | 5.3 | | | | | |
| | | acid | | | | | | | | | | | | | |
| | | aqueous | | | | | | | | | | | | | |
| | | solution | | | | | | | | | | | | | |
| | | 5% Nitric | | | | | | | | | 1.1 | 1.1 | | | |
| | | acid | | | | | | | | | | | | | |
| | | aqueous | | | | | | | | | | | | | |
| | | solution | | | | | | | | | | | | | |
| | | Formic Acid | | | 11.3 | 11.3 | | | | | | | 11.5 | 11.9 | |
| | Solvent | 1-Methoxy-2- | 48.7 | 48.7 | 37.5 | 37.5 | 69.2 | 69.3 | 70.3 | 69.6 | 71.2 | 72.7 | 38.5 | 39.7 | |
| | | propanol | | | | | | | | | | | | | |

| | | | | | | | | | | | | | | |
|---|---|---|---|---|---|---|---|---|---|---|---|---|---|---|
| Performance | Film thickness (μm) | 30 | 30 | 30 | 30 | 15 | 14 | 7 | 14 | 27 | 19 | 30 | 30 | 0 |
| evaluation | Anti-fogging properties | 151 | 163 | 44 | 47 | 6 | 8 | 9 | 14 | 4 | 13 | 7 | 14 | — |
| | (time at which fogging | | | | | | | | | | | | | |
| | begun (second)) | | | | | | | | | | | | | |

TABLE 2

| | | | | Compamtive |
|---|---|---|---|---|
| | | Example 1 | Example 2 | Example 1 |
| Performance | Anti-fogging properties (time at | 151 | 163 | 0 |
| evaluation | which fogging begun (second)) | | | |
| | Durability of anti-fogging effect (time at which | 157 | 159 | 0 |
| | fogging begun after 5 times repetition (second)) | | | |

The glass plates with the cured coating film obtained from (poly)glycerol-based alkoxysilane of the present invention in Examples 1 to 12 had sufficient anti-fogging properties with compared to that without application of the cured coating film in Comparative Example 1. Further, the glass plates in Examples 1 and 2 maintained the anti-fogging properties in the repeated anti-fogging tests.

Based on the evaluation results in Examples 1 to 12, it has been found that the cured coating film obtained from the (poly)glycerol-based alkoxysilane of the present invention has sufficient anti-fogging properties and durability of anti-fogging effect.

1. A (poly)glycerol-based alkoxysilane, comprising a (poly)glycerol skeleton with an average polymerization degree of 1 to 100, and a plurality of alkoxysilyl groups at a terminal.

2. The (poly)glycerol-based alkoxysilane according to claim 1, wherein the (poly)glycerol-based alkoxysilane is a reaction product obtained by reacting a (poly)glycerol or (poly)glycerol derivative having a first reactive functional group at a terminal with an alkoxysilane having a second reactive functional group at a terminal, wherein the first reactive functional group is reacted with the second reactive functional group.

3. The (poly)glycerol-based alkoxysilane according to claim 1, wherein the (poly)glycerol or (poly)glycerol derivative having a first reactive functional group at a terminal according to claim 2 has a structure represented by the following formula (1): 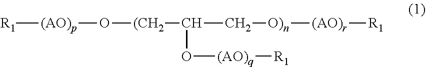
wherein n, p, q and r each represent the number of repeating unit, n being an integer of 1 to 100, p, q and r each being an integer of 0 to 50; AO represents an alkylene oxide having 1 to 4 carbon atoms; and R₁ represents reactive functional groups which may be the same or different and are selected from the group consisting of hydrogen, a thiol group, a (meth)acryloyl group, an epoxy group and an allyl group.

4. The (poly)glycerol-based alkoxysilane according to claim 2, wherein the second reactive functional group is one selected from the group consisting of a vinyl group, an isocyanate group, a thiol group, a (meth)acryloyl group, an epoxy group, a hydroxyl group, and an amino group.

5. The (poly)glycerol-based alkoxysilane according to claim 3, wherein the second reactive functional group is one selected from the group consisting of a vinyl group, an isocyanate group, a thiol group, a (meth)acryloyl group, an epoxy group, a hydroxyl group, and an amino group.

6. A method of anti-fogging a base material surface comprising applying the (poly)glycerol-based alkoxysilane of claim 1 onto said base material surface.

7. The method of anti-fogging a base material surface according to claim 6 wherein the (poly)glycerol-based alkoxysilane is a reaction product obtained by reacting a (poly)glycerol or (poly)glycerol derivative having a first reactive functional group at a terminal with an alkoxysilane having a second reactive functional group at a terminal, wherein the first reactive functional group is reacted with the second reactive functional group.

8. The method of anti-fogging a base material surface according to claim 7 wherein the (poly)glycerol or (poly)glycerol derivative having a first reactive functional group at a terminal according to claim 2 has a structure represented by the following formula (1):

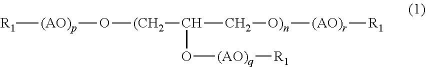

9. The method of anti-fogging a base material surface according to claim 7 wherein the second reactive functional group is one selected from the group consisting of a vinyl group, an isocyanate group, a thiol group, a (meth)acryloyl group, an epoxy group, a hydroxyl group, and an amino group.

10. The method of anti-fogging a base material surface according to claim 8 wherein the second reactive functional group is one selected from the group consisting of a vinyl group, an isocyanate group, a thiol group, a (meth)acryloyl group, an epoxy group, a hydroxyl group, and an amino group.
